(19) United States
(12) Patent Application Publication
(10) Pub. No.: US 2004/0139265 A1
(43) Pub. Date: Jul. 15, 2004

(54) Interfacing a battery-powered device to a computer using a bus interface

(75) Inventors: Lon O. Hocker III, Hilo, HI (US); Mark A. Hruska, Hilo, HI (US)

Correspondence Address: WEINGARTEN, SCHURGIN, GAGNEBIN & LEBOVICI LLP, TEN POST OFFICE SQUARE, BOSTON, MA, 02109, US

(73) Assignee: Onset Corporation

(21) Appl. No.: 10/694,166

(22) Filed: Oct. 27, 2003

Related U.S. Application Data
(60) Provisional application No. 60/439,220, filed on Jan. 10, 2003.

(51) Int. Cl. G06F 13/14

(52) U.S. Cl. 710/305

(57) ABSTRACT

An interface system for interfacing a computer to a battery-powered sensor system is disclosed. The interface system includes first and second modules coupled between the computer and the battery-powered system. The interface system operates independent of the sensor system with respect to transmitting and receiving data to/from the computer and receiving sensor data, respectively, but cooperate when transferring data therebetween. One module of the interface system, which includes a microcomputer and memory, adapts data format in accordance with the timing and data format requirements of the computer and the battery-powered sensor system. The other module of the interface system enables the exchange of data between the battery-powered sensor system and the computer despite differing operating voltage ranges.

### CROSS REFERENCE TO RELATED APPLICATIONS

This application claims priority to U.S. Provisional Patent Application 60/439,220, entitled “Interfacing a Low Power Device (LPD) to the Universal Serial Bus (USB)” filed Jan. 10, 2003.

### STATEMENT REGARDING FEDERALLY SPONSORED RESEARCH OR DEVELOPMENT

N/A

### BACKGROUND OF THE INVENTION

This invention relates generally to interfacing battery-powered devices to computers and in particular to interfacing battery-powered devices to computers using a bus provided interface.

A battery-powered device (BPD) is typically used to collect data at remote sites where power is not readily or easily obtainable, the power is unreliable, or when the BPD must be electrically isolated from the power supply for safety reasons. In general, a BPD can be used to measure variables such as temperature, PH, RH, pressure, and physiological variables such as temperature measurements or EKG measurements of animals or humans.

Typically to transfer data to a computer, a BPD is interfaced to the computer via a serial interface, such as the RS-232 interface. The RS-232 serial interface is a relatively simple interface and due to this simplicity the RS-232 is limited in its overall data transfer rate and its overall capability.

Current computers have replaced the RS-232 interface with the faster, more complex, more capable, and more flexible Universal Serial Bus (USB) interface that is coupled to a USB device or a USB compliant system that is typically external to the computer. Generally, the components comprising the USB device are powered by a 5-volt power signal, which is provided by the USB interface. Thus, the USB device is not powered unless it is coupled to the USB interface.

In some circumstances a BPD is designed to operate autonomously, that is, the BPD is designed to collect data independently of a computer and is connected to a computer only for setup and data readout. This class of BPD is typically powered by inexpensive and widely available 3-volt button batteries. The difference in operating voltages between the USB device and the BPD can cause over-voltage conditions to occur in the BPD when the two systems are electrically coupled together. Moreover, the data signals generated by the two systems will each have different “1” and “0” voltage levels that may result in the misinterpretation of the respective data signals.

One possible solution to the above problem is to design a USB device that is powered by the BPD and not the USB interface. As discussed above, USB devices require 5-volts power to operate and therefore are not compatible with the BPD 3-volt power supply due to its inadequate voltage and inadequate peak current capability. This solution would require the design of unique USB devices that are only suitable for use with BPDs and would therefore increase the overall cost of the system.

Another possible solution is to switch the power to the USB device from the USB interface to the BPD power supply when connected to a BPD. However, this would require power conditioning and power switching circuitry that would increase the complexity of the system. This would raise the cost of the system and decrease the reliability.

Another solution would be to power the BPD from the USB 5-volt power signal when the USB device is connected to the BPD. As with the previous solution, this would require complicated power switching and power conditioning circuitry to be added to the BPD. This additional circuitry would increase the complexity and the cost of the BPD and also would reduce the reliability of the BPD. In addition, adding additional circuitry to the BPD will decrease the battery life of the BPD further adding to the cost and reducing the reliability of the BPD.

Therefore, it would be desirable to provide an interface between a BPD and a computer serial interface that isolates the two systems and allows for data to be transferred back and forth with a minimum of complications.

### BRIEF SUMMARY OF THE INVENTION

An apparatus for enabling data transfer between first and second systems having distinct operating voltages is disclosed. In a preferred embodiment, the two systems are provided as a battery-powered, microcomputer-controlled data collection device, also referred to as a battery-powered device (BPD), and a computer having a USB interface. The apparatus includes a microcomputer-based, USB-compatible sub-system disposed in the data path between the computer and the BPD. The sub-system, also referred to as the USB microcomputer or “USBm,” is powered by the power signal from the computer's USB interface and is configured to selectively exchange data with each of the computer and the BPD.

Depending upon the embodiment, the BPD microcomputer or “BPDm” may be selectively connected to the USBm or may be continuously connected thereto. The BPDm and the USBm are designed to operate independent of one another when the BPDm is gathering data from a sensor it is communicating with and when the USBm is exchanging data with a computer it is connected to. However, when in mutual communication, the BPDm and the USBm are configured to enable mutual data exchange, despite the difference in operating voltages. Each of the BPDm and the USBm is capable of controlling the transmission of data to the other according to applicable timing and signal level requirements.

While described in terms of the BPD/USB preferred embodiment, it will be appreciated that the general concepts disclosed herein find applicability to a variety of systems having disparate operating characteristics.

Other features, aspects and advantages of the above-described method and system will be apparent from the detailed description of the invention that follows.

### BRIEF DESCRIPTION OF THE SEVERAL VIEWS OF THE DRAWING

The invention will be more fully understood by reference to the following detailed description of the invention in conjunction with the drawing of which:

FIG. 1 is a block diagram depicting a system operative in a manner consistent with the present invention;

FIG. 2A is a circuit diagram that depicts an embodiment of a portion of the interface system depicted in FIG. 1;

FIG. 2B is a block diagram that depicts another embodiment of a portion of the interface system depicted in FIG. 1; and

FIG. 3 is a timing diagram depicting a timing methodology that is suitable for use with the presently disclosed invention.

### DETAILED DESCRIPTION OF THE INVENTION

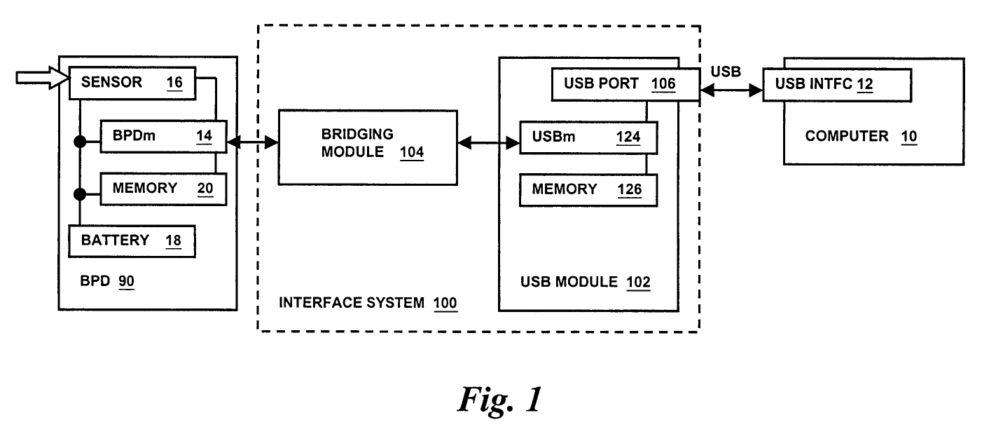

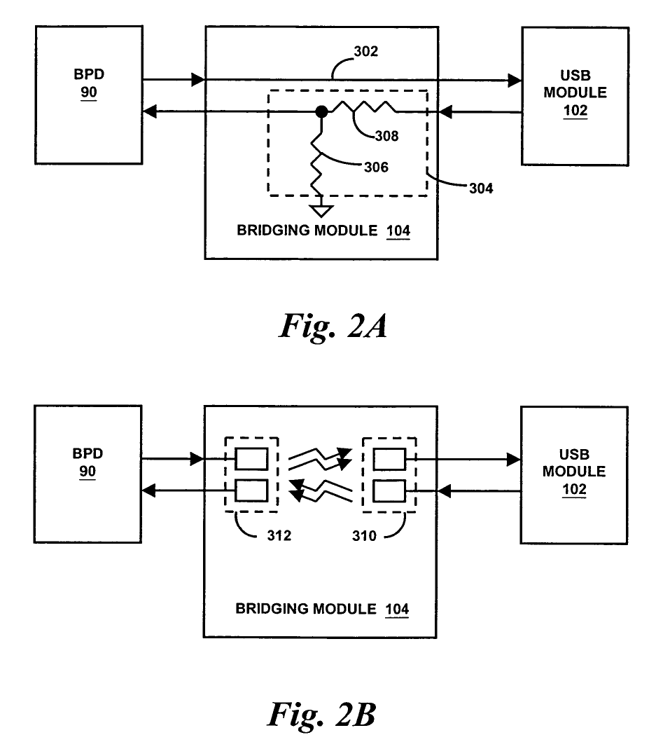

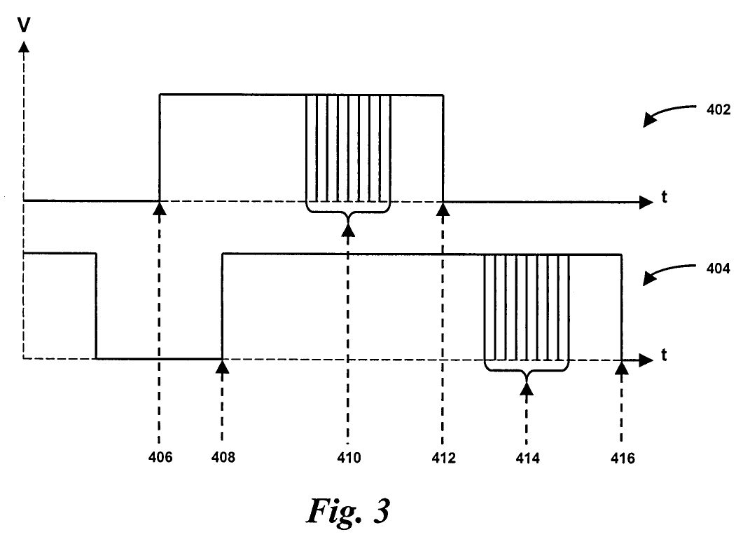

A system and method for interfacing a battery-powered, microcomputer-controlled data collection device, also referred to as a battery-powered device or “BPD,” to a communications port such as a USB port on a computer is disclosed. In the description of the figures that follow, FIG. 1 discloses a basic overview of the apparatus and FIGS. 2A and 2B depict the various components of one embodiment of the system in greater detail. FIG. 3 depicts a timing methodology that can be used in conjunction with the various embodiments of the apparatus described herein to communicate between the computer and the BPD.

As used herein, the computer is typically a microcomputer or microcontroller and includes at a minimum a power supply, a processor, an operating system, a communications interface, a semiconductor memory, and a memory storage device such as a hard-drive or a writeable optical drive. In the illustrative embodiment described below, the communications interface is a Universal Serial Bus (USB) port. The BPD is typically a battery-powered, microcomputer-controlled sensor system. The BPD microcomputer itself, referred to herein as the “BPDm,” is intended to provide sensor data to the computer.

The systems and timing methodologies described herein are applicable in general to any battery-powered device that needs to be interfaced to a computer. Moreover, the systems and methods described herein are not to be limited solely to embodiments including a battery-powered device, but are applicable to any system having two or more intercommunicating components that operate within different electrical operating ranges. Finally, the concepts of the described system and timing methodology are applicable to other serial and non-serial data interfaces and data transfer protocols.

FIG. 1 depicts a first embodiment of an interface system 100 for interfacing a computer 10 having a USB interface 12 to a BPDm 14 having a battery power supply 18. The interface system 100 includes two components.

The first of these components is a microcomputer-based, USB-compatible sub-system, also referred to as a USB module 102. The USB module houses a USB microcomputer or “USBm” 124. The USBm 124, in a first embodiment, is powered by the USB interface 12 of the computer 10. In an alternative embodiment to be described below, the USB module 102 has its own power supply (not illustrated), thus enabling USBm 124 operation when not in communication with the computer's USB port 12. As noted above, the USB module 102 itself is provided with a USB-compliant port 106.

The other portion of the interface system 100 is a bridging module 104. The purpose of the bridging module 104 is to account for differences in the electrical operating ranges of the BPD 90 and the computer's USB bus and/or to electrically isolate the two systems. The bridging module 104 is in selective electrical communication with both the BPDm 14 and the USBm 124. As will be described subsequently, the bridging module can be implemented in a variety of ways depending upon overall system requirements.

In one embodiment of the presently disclosed concept, the interface system 100, including the USB module 102 and the bridging module 104, is physically included within the BPD 90 housing, along with the BPDm 14. In this embodiment, the USBm 124, bridging module 104, and BPDm 14 may all be disposed on a common circuit board, on individual boards, or some combination thereof. The external connection from the BPD 90 housing is the USB port 106 capable of interfacing the BPD 90 to the USB interface 12 of the computer 10. BPD data would then be accessible to a data gathering computer via a USB connection. Other physical configurations, including several in which the interface system 100 is housed in its own enclosure, are possible and will be discussed in more detail below.

Typically, the USB interface 12 of the computer 10 operates within an electrical operating range that differs from that of the BPDm 14. For instance, the USB is a five-volt bus, while the BPD typically operates off a three-volt battery supply. Accordingly, data generated and output by either the computer 10 or the BPDm 14 may not be electrically compatible with the receiving system. In addition, the data timing requirements of the computer 10 and BPDm 14 may be incompatible. To address these issues, the interface system 100 receives data from the USB interface 12 and from the BPDm 14, selectively stores the received data, and retransmits the data in an electrical and timing format that ensures proper reception and interpretation at the receiving device.

The USB module 102 includes the USBm 124 and an associated memory 126. As noted above, the USBm 124 may be capable of communicating with a computer's USB port 12 through its own USB-compliant port 106. Processing performed by the USBm 124 may involve modifying the format, timing, frequency, amplitude or other signal characteristic(s) of the received data so that the data is compatible with the receiving device. Typically, the signals are stored in the memory 126 prior to processing; however, in some circumstances real time processing may be needed due to system requirements. The memory 126 is provided as a ROM, RAM, PROM, EEPROM, or other suitable type and is sized to provide sufficient memory storage for programs to be executed by the USBm 124 and to store any data necessary for the execution of these programs.

The USB module 102 is in communication with the BPD 90 via the bridging module 104. The bridging module 104 is hard-wired to each of the USBm 124 and the BPDm 14, though as discussed subsequently, the bridging module 104 itself may assume a variety of forms, depending upon the needs of the particular application.

The use of two separate microprocessors, i.e. the USBm 124 and the BPDm 14, allows the USBm 124 and the BPDm 14 to act independent of one another when communicating with the computer 10 or the sensor 16, respectively, but to cooperate when transferring data therebetween. The data store and forward function of the USBm 124, with any necessary data processing and reformatting, allows the data to be exchanged between the computer 10 and the BPDm 14, regardless of timing and voltage range differences. In addition, the cooperative interaction between the USB module 102 and the BPDm 14 allows data to be transferred therebetween independent of the computer 10.

As an example, data from the computer 10 is passed to the USB module 102 according to USB timing and voltage parameters, independent of the timing requirements of the BPDm 14. The data is then transferred to the BPDm 14 via the bridging module 104 at an appropriate time, such as when the BPDm 14 is not receiving data from the sensor 16, independent of the computer 10. Data is capable of being transferred from the BPDm 14 to the computer 10 using a similar sequence.

In one embodiment discussed above, the USBm 124 is powered by the +5-volt power signal provided by the USB interface 12 and operates and generates signals within the first electrical operating range. Similarly, the BPDm 14 is powered by the battery power supply 18 of the BPD 90 and operates and generates signals within the second electrical operating range. The battery power supply voltage level is often lower than the +5-volt power signal of the USB interface 12. Accordingly, although the USBm 124 is operative to adapt the received data signals into a data format that is compatible with the BPDm 14, in some circumstances, due to the different electrical operating ranges, signals generated by the USBm 12 cannot be properly received and/or interpreted accurately by the BPDm 14. In other circumstances, electrical isolation between the two microcomputer systems 102, 90 is needed for safety or other reasons.

In the circumstances where the USBm 124 and the BPD 90 are not electrically compatible or where direct connection is not desirable, the interface system 100 uses the bridging module 104 between the BPDm 14 and the USBm 124, as shown in FIGS. 2A and 2B. The bridging module 104 in the illustrated embodiments is shown as a discrete module coupled to the USB module 102 and the BPD 90 via a two-wire interconnection. Preferably, however, the bridging module 104 is integral with either the USB module 102, the BPD 90, or divided between the two.

In general, the bridging module 104 provides components for adjusting or modifying one or more signal characteristics. This circuitry can include analog circuitry, digital circuitry, and/or microprocessors or digital signal processors, the selection of which is based on the overall system design.

In the embodiment depicted in FIG. 2A, the bridging module 104 couples the BPD 90, operating from a 3-volt battery, to the USB module 102, operating from the +5-volt power signal provided by the USB interface 12. In this embodiment, the signals provided by the BPD 90 are compatible with the USB module 102 in terms of voltage level. Accordingly, the signals provided by the BPD 90 are passed to the USB module 102 via direct electrical connection 302. However, the signals provided by the USB module 102 are not compatible with the BPD 90 due to the higher voltage level. The signals provided by the USB module 102 are passed through a level shifting circuit 304 to adjust the signal level of the USB module-generated data signals. In the illustrated embodiment, the level shifting circuit 304 is a voltage divider comprised of first and second resistors 306, 308 that are 4.7 K-ohms each. Other level shifting circuits that may include active components and/or passive components may be used to increase or decrease the signal level as needed.

In another embodiment, depicted in FIG. 2B, the bridging module 104 is comprised of optical transmitter/receiver pairs 310, 312. These optical elements 310, 312 are used to electrically isolate the USB module 102 from the BPD 90. The different signal levels are adjusted at each optical transmitter so that optical signals having the correct levels are transmitted to the corresponding optical receiver. The embodiment of FIG. 2B could also be modified to include RF transceivers.

In another embodiment, it may be desirable to directly couple the two systems via an AC coupling system (not illustrated) that is contained within the bridging module 104. The AC coupling system within the bridging module 104 may include, for example, an electrical network that preserves or filters the various signal levels and may include a blocking capacitor such that no DC energy is passed from one system to the other. In addition, suitable current limiting circuitry can be included to prevent excess current from being coupled between the USB module 102 and the BPDm 14.

In the timing methodology described below, the USB module 102 only communicates with the BPD 90 when the computer 10 requires data from the BPDm 14 and requests this data via the USB interface 12. The USB module 102 receives this request, modifies the request as required, and passes this request to the BPDm 14. The requested data, which is retrieved from the BPDm 14, is provided by the BPD 90 to the USB module 102 via one of the embodiments of the bridging module 104 described above using the timing methodology described below. The USB module 102 then provides the retrieved data to the USB interface 12 at an appropriate time.

Alternatively, the computer 10 to BPDm 14 communication may be for the purpose of downloading data such as operating instructions or configuration data to the BPDm 14.

A timing methodology that is suitable for use with the embodiments of the interface system 100 described herein is depicted in FIG. 3. FIG. 3 depicts signals transmitted from the USB module 102 to the BPD 90 as plot 402, and signals transmitted from the BPD 90 to the USB module 102 as plot 404. In this timing methodology, communication is initiated by the USB module 102 and in FIG. 3 this is depicted at time 406 when the USB module 102 drives the output signal to the BPD 90 high. The BPD 90 acknowledges by pulling its output signal high at time 408, indicating that it is ready to receive communications from the USB module 102. In response to the high signal at 408, the USB module 102 provides the commands or data to the BPD 90 at time 410. When the USB module 102 has finished sending the desired commands and data, it drives the output signal low at time 412, indicating to the BPD 90 that it has finished transferring data.

In the event that the BPDm 14 is required to respond to the USB module 102, the BPDm 14 first monitors the output signal from the USB module 102 for a predetermined period to ensure that the signal is low and stays low. The BPDm 14 then transfers the desired data at time 414. When the BPDm 14 has completed sending the desired data, it sets the output signal to a low state at time 416.

In the embodiment of FIG. 2A in which an electrical connection is used, the quiescent state of the two communications lines is low. This ensures that there is no data loss in the event that the USB module 102 system is not connected to the USB interface 12 and therefore un-powered, since the normal state is low and a high state is used to request and acknowledge communications. In addition, in the event that the BPD 90 is coupled to the USB module 102 but is un-powered, it would be undesirable to have the powered USB module 102 driving a high quiescent level into the un-powered BPD 90.

This communications protocol can also be used in optically coupled systems, such as that illustrated in FIG. 2B. However, in an optically coupled system, the quiescent condition of the two data receivers is high instead of low. In addition, this protocol can also be used for RF coupled systems in which separate RF channels are used to transmit and receive data.

In the timing methodology depicted in FIG. 3 and described above, the BPDm 14 devotes its resources completely to the transfer request from the USB module 102 after it has acknowledged the request by pulling its output high at 408. The request can be handled typically in a small time period such that the probability of the BPDm 14 missing data from the sensor 16 is kept to a minimum. It is undesirable during any communications between the USB module 102 and BPDm 14 for the BPDm 14 to be the source of a communications failure. In the event that the BPDm 14 fails, for example due to battery failure, the USB module 102 will be pulled back into operation by a USB watchdog timer located either within the USB module 102 or in the USB interface 12. Similarly, disconnection of the USB module 102 from the USB interface 12 removes the power signal from the USB module 102 and it is important that the BPDm 14 not “lock-up” to avoid a loss of sensor data from the BPD 90. Preferably, the BPDm 14 monitors the output line of the USB module 102 for a low state occurrence that has a predetermined duration. In the event that the USB module 102 loses power, the BPDm 14 should be designed to drop its output line low after the predetermined time, to ignore the command that had started issuing from the USB module 102, and furthermore to shut off the internal oscillator, if appropriate.

As is known, the USB interface 12 requests enumeration data from any device that is connected to it. The enumeration data can either be uploaded from the BPD 90 and stored in the USB module 102, or the enumeration data can be provided by the BPDm 14 itself. If the data is provided directly from the BPDm 14, it may be desirable to provide a duplicate set of enumeration data in the USB module 102 as well. In this way, in the event that the battery 18 providing power to the BPD 90 is interrupted for some reason, the enumeration data is still available. In the event that the BPDm 14 fails to respond, the USB module 102 can respond to the enumeration request by enumerating a device with a dead battery, a missing device, a USB device in communication with an unresponsive BPD, or simply as a USB device. In one embodiment, the USB module 102 may test for an unresponsive BPDm 14 by briefly pulsing the input line from the BPDm 14 and reading the voltage level on the line. If it stays high for a predetermined period, the USB module 102 may conclude that there is nothing driving the line and therefore that a BPD is not currently connected or operating properly.

In the embodiments described above, to preserve battery life, the microprocessor, digital signal processor (DSP), and/or microcontroller used as the BPDm 14 is preferably a low power device. These low power devices typically include an internal clock with an attached timer, and in addition have a slower low-power RC oscillator that also has access to an attached timer. The slower RC oscillators use less power than the faster internal oscillator. In addition, the processor, DSP, or controller will switch internally at the slower switching speed and use less power than when switched at higher clock frequency. In general, because the RC oscillators have a very short start up time compared to the internal clock, they are used to minimize the operating time of the microprocessor or microcontroller, thus minimizing power consumption. The timers associated with the RC oscillators can be used to awaken the internal oscillator after a predetermined period of time to check for a communications request.

One problem in these systems is that the RC oscillator frequency may vary up to 10%, which can adversely affect the data transfer. Therefore, when a microprocessor or microcontroller uses a low-power RC oscillator, the data must be transferred by a method that is tolerant of the large frequency variations that may occur. Such methods include ⅓, ⅔ encoding and Manchester encoding. Ideally, the transfer rates should be as fast as possible to minimize the time needed to transfer data between the BPD 90 and the host computer 10 and thus to minimize the power consumed in the BPD 90 during the data transfer operation.

In the foregoing, a preferred embodiment has been described in which the interface system 100 is disposed within a housing associated with the BPD 90. In another embodiment, it may be advantageous to place the USB module 102 in a separate physical enclosure. The bridging module 104, if needed, can be enclosed either in conjunction with the BPD 90 or, if the USB module 102 is separately housed, with the USB module 102. If the bridging module implements optical isolation, one transmitter/receiver pair 312 is disposed in conjunction with the BPD 90 and the other is located with the USB module 102.

In non-optical embodiments and to avoid draining the battery power supply 18 when not in use, it is advantageous to physically place the bridging module 104 in the physical enclosure with the USB module 102. In this embodiment, the bridging module 104 may be on the same circuit board as the USBm 124, or on a separate circuit board, again depending on the system requirements.

In some circumstances, a plurality of BPDs may be used to collect data, each of the plurality of BPDs needing to be selectively interfaced to one or more computers. In this case, a USB device is required that can be moved from BPD to BPD as a USB shuttle for collecting data from each BPD. In one embodiment, the self-powered USB shuttle can be configured as a USB On-The-Go (OTG) shuttle and can include a USB module 102 for collecting data from each BPD, for storing the collected data in memory 126, and for uploading the collected data via a USB port 106 when connected to the computer(s) 10 and enumerated as peripheral thereto. The USB OTG shuttle can also be programmed with configuration data intended for download to one or more BPDs 90. In this role, the USB OTG shuttle is capable of enumerating the BPD 90 and controlling the downloading and/or uploading of data, as necessary. The USB OTG shuttle acts both as a master, when exchanging data with a BPD 90, and a slave, when exchanging data with the computer 10 via the USB interface contained thereon.

In another embodiment, the USB module 102 of the USB shuttle has sufficient programmed intelligence to enable independent data upload from a BPD 90. The shuttle can then be connected to the USB interface 12 of the computer 10 for upload under the control of the computer 10. In one less expensive version of this embodiment, a single microprocessor in the shuttle is used for interfacing to the BPDm 14 and the computer 10. In another lower power version, two microprocessors are used in the shuttle, one operating at the BPD voltage and the other operating at the higher USB voltage. Appropriate level-shifting circuitry, such as shown in the bridging module 104, would also be provided in a two-microprocessor embodiment. Battery power would be present in either version of such a shuttle.

It should be appreciated that other variations to and modifications of the above-described method and system for interfacing a battery-powered device to a computer may be made without departing from the inventive concepts described herein. Accordingly, the invention should not be viewed as limited except by the scope and spirit of the appended claims.

What is claimed is:

1. An apparatus for enabling communications between a computer and a battery-powered device, each having an interface for sending and receiving respective data signals and for providing a respective power signal, the electrical operating ranges of the computer-provided and battery-powered device-provided power signals being dissimilar, the apparatus comprising:
a microcomputer module comprising an interface for exchanging data signals with the computer and for receiving the power signal from the computer, a microcomputer for controlling the exchange of data via the module interface, and a memory element for storing microcomputer operating instructions and data processed thereby, the microcomputer operating in the electrical operating range of the computer and selectively reformatting data in accordance with the formatting requirements of the computer and the battery-powered device, respectively; and
a bridging module in communication with the microcomputer of the microcomputer module and the battery-powered device and adapted to compensate for the dissimilar electrical operating ranges of data exchanged between the computer and the battery-powered device via the bridging module,
whereby data transmitted by the computer via the computer interface is received at the microcomputer via the module interface, selectively reformatted by the microcomputer, and transmitted to the battery-powered device via the bridging element, and
whereby data transmitted by the battery-powered device is received at the microcomputer module via the bridging element, selectively reformatted by the microcomputer, transmitted to the computer by the module interface, and received by the computer via the computer interface.

2. The apparatus of claim 1, wherein the bridging module is operative to modify at least a portion of the exchanged data into a form compatible with the electrical operating range associated with the computer or battery-powered device receiving the exchanged data.

3. The apparatus of claim 2 wherein the bridging module comprises a level shifting circuit to alter the amplitude of at least a portion of the exchanged data into a form compatible with the electrical operating range associated with the computer or battery-powered device receiving the exchanged data.

4. The apparatus of claim 3, wherein the level shifting circuit comprises:
a direct electrical connection for conveying data from the battery-powered device to the microcomputer module; and
an electrical connection including a level shifting circuit to reduce the amplitude of the data conveyed from the microcomputer module to the battery-powered device.

5. The apparatus of claim 4 wherein the level shifting circuit is a voltage divider circuit.

6. The apparatus of claim 2 wherein the bridging module comprises a wireless communications link between the microcomputer module and the battery-powered device.

7. The apparatus of claim 6 wherein the wireless communications link comprises an optical transmitter and receiver in communication with each of the microcomputer module and the battery-powered device.

8. The apparatus of claim 6 wherein the wireless communications link comprises an RF transmitter and RF receiver in communication with each of the microcomputer module and the battery-powered device.

9. The apparatus of claim 2 wherein the bridging module comprises a fiber-coupled optical communications link.

10. The apparatus of claim 1 wherein the computer interface is a USB interface and the module interface is a USB-compliant interface.

11. The apparatus of claim 1, wherein the microcomputer is operative to store data in the memory element prior to transmitting it to the computer or the battery-powered device.

12. The apparatus of claim 1, wherein the microcomputer is operative to transmit data to the computer and the battery-powered device at dissimilar rates.

13. The apparatus of claim 1, wherein the microcomputer is operative to transmit data to the battery-powered device at a rate slower than that at which the microcomputer transmits data to the computer.

14. The apparatus of claim 13 wherein a data signal for data transfers from the second system to the first system is encoded using a ¼, ¾ with a nominal 4-microsecond bit cell and a data signal for data transfers from the first system to the second system is encoded using a 4/14, 10/14 with a nominal 14-microsecond bit cell.

15. The apparatus of claim 1 wherein the data transmitted by the microcomputer to the battery-powered device via the bridging module is encoded using Manchester encoding.

16. The apparatus of claim 1, wherein the battery-powered device, bridging module and microcomputer module are disposed in a common enclosure.

17. The apparatus of claim 1, wherein the bridging module and the microcomputer module are disposed in a first enclosure selectively coupleable to the computer and to the battery-powered device.

18. The apparatus of claim 1, wherein a first portion of the bridging module is physically housed with the battery-powered device and a second portion of the bridging module is physically housed with the microcomputer module, the first and second portions of the bridging module being selectively coupleable and the computer interface and the module interface being selectively coupleable.

19. The apparatus of claim 1, wherein the microcomputer module further comprises a power supply for enabling microcomputer operation independent of the computer-provided power signal.

20. A system for enabling communications between a port of a computer and a low-power device, the computer and the battery-power device having dissimilar electrical operating ranges, the system comprising:
a bus module having
a module port compatible with the computer port and selectively coupleable therewith,
a microcomputer in communication with the module port and operative to exchange data with the computer via the module and computer ports,
a memory in communication with the microcomputer for enabling the selective storage of data by the microcomputer and for storing instructions executable by the microcomputer; and
a bridging module having a first end in communication with the microcomputer and a second end in communication with the low-power device, the bridging module for enabling the exchange of data between the microcomputer and the low-power device despite the dissimilar respective electrical operating ranges.

21. The system of claim 20, wherein the microcomputer is operable to selectively reformat data exchanged between the computer and the low-power device.

22. The system of claim 20, wherein the bridging module selectively modifies the electrical levels of the data exchanged thereby.

23. The system of claim 22, wherein the bridging module alters the voltage levels of data transmitted to the low-power device.

24. The system of claim 20, wherein the first and second ends of the bridging module are optically coupled.

25. The system of claim 20, wherein the first and second ends of the bridging module are wirelessly coupled.

26. The system of claim 20, wherein the low-power device, the bridging module, and the bus module are disposed within a common physical enclosure.

27. The system of claim 20, wherein a first portion of the bridging module is commonly housed with the low-power device and a second portion of the bridging module is commonly housed with the bus module.

28. The system of claim 27, wherein the first and second portions of the bridging module are selectively coupleable and the bus module and the computer are selectively coupleable.

29. The system of claim 20, wherein the bus module further comprises a power supply for microcomputer operation independent of a power signal provided by the computer port.
